(19) United States
(12) Patent Application Publication
(10) Pub. No.: US 2022/0011987 A1
(43) Pub. Date: Jan. 13, 2022

(54) INFORMATION PROCESSING SYSTEM, INFORMATION PROCESSING APPARATUS, AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Mamoru MOCHIZUKI, Kanagawa (JP)

(73) Assignee: FUJIFILM Business Innovation Corp., Tokyo (JP)

(21) Appl. No.: 17/146,387

(22) Filed: Jan. 11, 2021

(30) Foreign Application Priority Data
Jul. 9, 2020 (JP) 2020-118766

(51) Int. Cl. G06F 3/12

(52) U.S. Cl. CPC G06F 3/1206; G06F 3/1287; G06F 3/1225; G06F 3/1255

(57) ABSTRACT

An information processing system includes a processing request transmission device including a processing request transmission device including a transmission-side processor configured to transmit a processing request including target data to be processed and a correspondence program information indicating a correspondence processing control program being a processing control program corresponding to the processing request, in association with each other, and an information processing apparatus including a processing-side processor configured to execute processing on the target data by executing the correspondence processing control program.

### CROSS-REFERENCE TO RELATED APPLICATIONS

This application is based on and claims priority under 35 USC 119 from Japanese Patent Application No. 2020-118766 filed Jul. 9, 2020.

### BACKGROUND

### (i) Technical Field

The present invention relates to an information processing system, an information processing apparatus, and a non-transitory computer readable medium storing an information processing program.

### (ii) Related Art

JP2001-027940A discloses a printing system including a printer and a host computer that transmits a processing request to the printer. The printing system upgrades a control program and a printer driver based on compatibility information indicating the compatibility between the control program of the printer and the printer driver of the host computer while holding the compatibility between the control program and the printer driver.

JP2002-211086A discloses a printing device including a printer controller. In the printing device, a boot program and a download program are stored in a read only memory (ROM) of the printer controller without storing an image processing main program, and the image processing main program downloaded from a host by the download program is booted by the boot program, and thereby print processing is executed.

JP2007-052666A discloses an image processing apparatus on which software for performing image processing is installed. The image processing apparatus performs processing of restoring the software to the previous version in a case where the software is updated to a new version, and then a problem occurs continuously a predetermined number or more of times.

### SUMMARY

In the related art, an information processing system as follows is known. The information processing system includes a processing request transmission device and an information processing apparatus. A processing request is transmitted from the processing request transmission device to the information processing apparatus, and the information processing apparatus executes processing related to the processing request.

In the information processing apparatus in such an information processing system, generally, processing on target data related to the processing request is executed by executing a processing control program. An example of a processing control program is a print control program for executing rasterization processing or the like on target data (for example, electronic document) related to a printing job as a processing request in a case where the information processing apparatus is a printer controller.

The information processing apparatus may perform a plurality of functions for the processing on the target data. For example, in a case where the information processing apparatus is a printer controller, a plurality of functions (for example, color conversion function, alignment adjustment processing function, background processing function, and spot color processing function) related to rasterization processing may be performed. In order for the information processing apparatus to perform each of the functions, the processing control program is required to be configured to be able to perform each of the function.

Here, it is considered that there is a function having a small use frequency among the plurality of functions that may be performed by the information processing apparatus. However, since it is not known when the function is used even though the function has a small use frequency, the processing control program is required to be configured to be able to perform the function. Thus, in the related art, a processing control program capable of performing all functions that may be performed by the information processing apparatus is stored in a memory of the information processing apparatus.

The processing control program capable of performing all the functions that may be performed by the information processing apparatus has a large data size. Thus, there is a problem that, in order to store such a processing control program, a large storage area is required in the memory of the information processing apparatus.

Aspects of non-limiting embodiments of the present disclosure relate to an information processing system, an information processing apparatus, and a non-transitory computer readable medium storing an information processing program, for reducing a storage area of a memory for storing a processing control program used to execute processing in comparison to a case where a processing control program capable of performing all functions that may be performed by the information processing apparatus is stored in advance in the memory of the information processing apparatus that executes processing on target data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processing request transmission device including a processing request transmission device including a transmission-side processor configured to transmit a processing request including target data to be processed and a correspondence program information indicating a correspondence processing control program being a processing control program corresponding to the processing request, in association with each other, and an information processing apparatus including a processing-side processor configured to execute processing on the target data by executing the correspondence processing control program.

### BRIEF DESCRIPTION OF THE DRAWINGS

Exemplary embodiment(s) of the present invention will be described in detail based on the following figures, wherein:

FIG. 1 is a schematic diagram illustrating a configuration of an information processing system according to an exemplary embodiment;

FIG. 2 is a schematic diagram illustrating a configuration of a job transmission device in the exemplary embodiment;

FIG. 3 is a conceptual diagram illustrating an example of contents of a program DB;

FIG. 4 is a conceptual diagram illustrating an example of contents of a user DB;

FIG. 5 is a conceptual diagram illustrating an example of contents of a job spool;

FIG. 6 is a diagram illustrating a first example of a job input screen;

FIG. 7 is a diagram illustrating a second example of the job input screen;

FIG. 8 is a conceptual diagram illustrating a data structure of a job file;

FIG. 9 is a schematic diagram illustrating a configuration of an information processing apparatus in the exemplary embodiment; and

FIG. 10 is a flowchart illustrating a processing flow of the information processing system in the exemplary embodiment.

### DETAILED DESCRIPTION

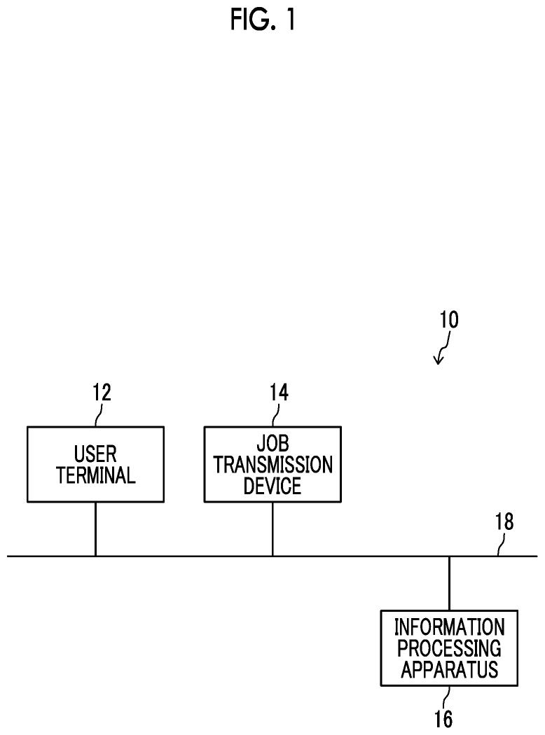

FIG. 1 is a schematic diagram illustrating a configuration of an information processing system 10 according to an exemplary embodiment. The information processing system 10 includes one or more user terminals 12, a job transmission device 14 as a processing request transmission device, and one or more information processing apparatuses 16. The user terminal 12, the job transmission device 14, and the information processing apparatus 16 are connected to each other via a communication line 18 such as a local area network (LAN) or the Internet, so as to enable communication with each other.

The general flow of processing of the information processing system 10 is as follows. Firstly, the job transmission device 14 receives a job as a processing request. For example, the job transmission device 14 receives a job from the user terminal 12. A user may directly operate the job transmission device 14 to input a job. The job transmission device 14 transmits the received job to the information processing apparatus 16, and the information processing apparatus 16 that has received the job executes processing on target data included in the job.

The user terminal 12 is a terminal used by the user. The user terminal 12 is, for example, a stationary personal computer or a portable terminal such as a smartphone or a tablet terminal. The user terminal 12 includes a communication interface for communicating with other devices, a memory, a display including a liquid display device or the like, an input interface including a mouse, a keyboard, a touch panel, or the like, and a processor including a central processing unit (CPU), a microcomputer, or the like. The memory includes a hard disk drive (HDD), a solid state drive (SSD), a read only memory (ROM), a random access memory (RAM), and the like.

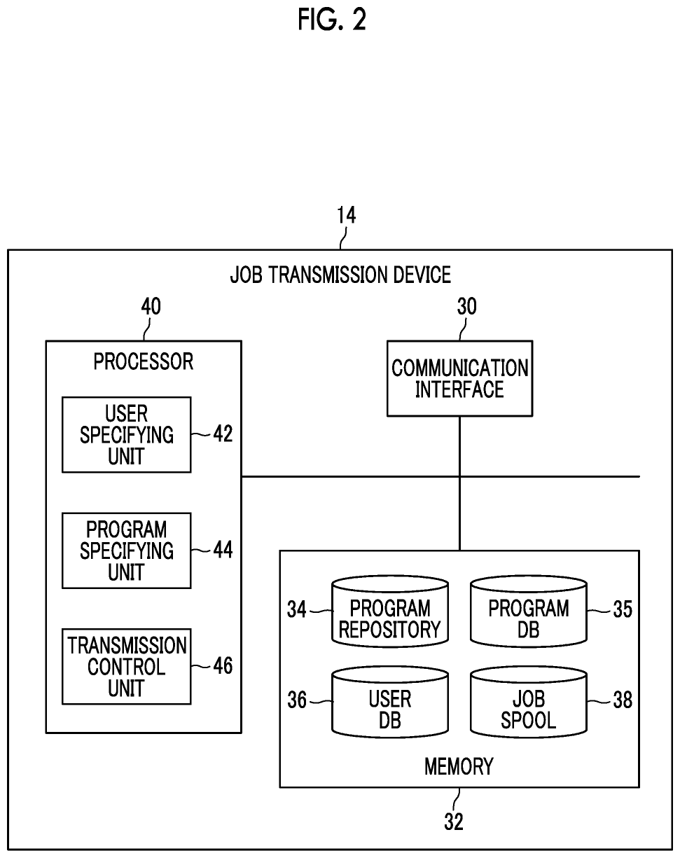

FIG. 2 is a schematic diagram illustrating a configuration of the job transmission device 14. In the exemplary embodiment, the job transmission device 14 is a server computer, but the job transmission device 14 may be any device as long as the device performs functions described below.

The communication interface 30 includes, for example, a network adapter. The communication interface 30 performs a function of communicating with another device via the communication line 18. The communication interface 30 receives a job from the user terminal 12. The communication interface 30 transmits the received job and correspondence program information (details will be described later) indicating a processing control program corresponding to the job, to the information processing apparatus 16.

In the exemplary embodiment, the job transmission device 14 is a server computer, and the communication interface 30 receives the job. The job transmission device 14 may include an input interface including, for example, a touch panel. A job may be input to the job transmission device 14 by the user operating the input interface.

The job includes target data to be processed and an execution command of processing. As an example of the job, there is a printing job of causing a printing device to execute print processing of printing target data on a print medium in a state where a printer controller as the information processing apparatus 16 executes rasterization processing on the target data, that is, executes processing of converting the target data into a data format recognizable by the printing device. In a case where the job is a printing job, the target data is, for example, an electronic document or image data. In this case, the target data is described in the page description language (PDL) such as Post Script (PS) or PDF.

The job may be any job as long as the job causes the information processing apparatus 16 to execute processing on the target data. The information processing apparatus 16 is not limited to the printer controller.

A memory 32 includes, for example, a HDD, an SSD, a ROM, and a RAM. The memory 32 may be provided separately from the processor 40 described later, or at least a portion of the memory 32 may be provided in the processor 40. The memory 32 stores a processing request transmission program for operating the units of the job transmission device 14. As illustrated in FIG. 2, a program repository 34, a program DB (database) 35, a user DB 36, and a job spool 38 are defined in the memory 32.

The processing control program is stored in the program repository 34. The processing control program is a program executed by the information processing apparatus 16, and is executed to cause the information processing apparatus 16 to execute processing on target data included in the job. The processing control program may be stored in the program repository 34 in an installer format (for example, exe file) or an archive format (for example, zip file or tar file).

An example of the processing control program is a print control program that for executing the above-described rasterization processing on target data. The processing control program is not limited to the print control program. For example, in a case where the job is a writing job of requesting writing processing of writing target data (for example, video data or music data) to a recording medium such as a digital versatile disc (DVD), the processing control program may be a writing control program for executing the writing processing. In such a writing control program, for example, in a case where target data that is for a DVD having a single-sided dual-layer structure and has a volume of about 8.5 gigabytes is written in a DVD having a single-sided single-layer structure (writable data volume is about 4.7 gigabytes), processing of compressing the target data to a volume of 4.7 gigabytes or less and the like are executed.

In a case where processing on target data is performed using processing control programs which execute similar processing and are different from each other, processing results may be different from each other. For example, in a case where the processing control program is the above-described print control program, and print processing is executed in a state where rasterization processing is executed using print processing control programs different from each other, the color tones in the print results may be slightly different from each other, or the arrangement relations (that is, layouts) between objects may be slightly different from each other. Alternatively, in a case using a certain print control program, a print result which is completely different from the intention of the user may be output. In a case where the processing control program is the above-described writing control program, and the writing processing is executed using writing control programs different from each other, for example, the compression methods of the target data are different from each other, so that image quality or sound quality of a DVD as the processing result may differ slightly. In addition, in a case where the processing control program is a display processing control program for displaying image data, moving image data, and the like, and processing is executed using display processing control programs different from each other, display characteristics such as the resolution of an image or a moving image to be displayed, color reproducibility, and gradation, and the compatibility with a display device are affected.

As described above, the processing result may change depending on the processing control program. Which processing control program is to be used may change depending on the preference of the user or the type of job or target data. For example, a case as follows is considered. That is, a user A prefers the processing result obtained by processing using a processing control program A to the processing result obtained by processing using a processing control program B, but a user prefers the processing result obtained by processing using the processing control program B to the processing result obtained by processing using the processing control program A. In addition, a case as follows is also considered. That is, in a case where target data A is processed using the processing control program A, a more appropriate processing result may be obtained than a processing result obtained in a case where the target data A is processed using the processing control program B. However, in a case where target data B is processed using the processing control program B, a more appropriate processing result may be obtained than a processing result obtained in a case where the target data B is processed using the processing control program A. There are many viewpoints on the quality of the processing result. In addition to being clean, “previous compatibility” also serves as a viewpoint. That is, it is assumed that a user has executed processing on the target data A using the processing control program A in the past. In a case where the identical processing is executed again after a while, the processing may be executed again with an expectation that the result similar to the previous processing result is obtained. For example, in a case of print processing, a case where printing for the identical appearance as the previous printer matter is performed again is considered. In a case where, processing has been executed before, and then the version of the processing control program is updated, the processing result may change even though the processing is executed using the identical processing control program A. In general, although the program has been updated to obtain some kinds of malfunction or the more advanced processing result, in a case of a user requiring more that the result which is similar to the previous output result is obtained again than such sophistication of the processing result, the processing control program A having the previous version is more proper than the processing control program A having the latest version.

The program repository 34 stores a plurality of processing control programs, in particular, a plurality of processing control programs for executing similar processing. For example, a plurality of print control programs are stored in the program repository 34. Alternatively, a plurality of writing control programs are stored in the program repository 34.

The program repository 34 may store a plurality of versions of a certain processing control program. For example, three versions of the processing control program A, which are version 1.0, version 1.1, and version 2.0, are stored.

The processing control program stored in the program repository 34 may be configured by a plurality of modules. For example, the processing control program A is configured by a module α, a module β, a module γ, and the like. The modules in the processing control program may be executed singly or in any combination. Each of the modules in the above-described processing control program A may be singly executed, and may be executed in a combination of the module α and the module β, a combination of the module α and the module γ, and the like. In a case where each of a plurality of processing control programs is configured by a plurality of modules, a combination of a plurality of modules selected from the processing control programs different from each other may be executed. For example, in a case where the processing control program A is configured by a module α, a module β, and a module γ, and the processing control program B is configured by a module δ and a module ε, a combination of the module α of the processing control program A and the module c of the processing control program B may be executed. Each of the modules in the processing control program corresponds to, for example, each function performed by the processing control program. In a case where a module has a plurality of versions, the program repository 34 may store the plurality of versions of the module.

Describing print processing as a specific example of the processing, the processing control program corresponding to a program for image processing. Examples of modules forming the program include an image smoothing filter module, an edge enhancement module, and a resolution conversion module, a color conversion module, a gradation adjustment module, a halftone module, a font drawing module, and a rotation module. The user requests the print processing as a printing job including data as a printing target and printing conditions. A program required to process the printing job is specified from print processing conditions in the printing job and the contents of a document as the printing target. For example, when executing the print processing based on the printing job, in a case where the processing can be performed using only the edge enhancement module, the halftone module, and the color conversion module among the above modules, the above-described modules are specified as a correspondence processing control program. In a case where it is necessary to perform the functions of all the modules in order to process another printing job, the entire image processing program including all the modules is specified as the correspondence processing control program.

A program ID for uniquely identifying each processing control program is assigned to the processing control program stored in the program repository 34. In the exemplary embodiment, a different program ID is assigned to the processing control program having a different version. In a case where the processing control program is configured by a plurality of modules, a different program ID is assigned to each module of each processing control program or each combination of modules of a plurality of processing control programs.

In the exemplary embodiment, the program repository 34 is stored in the memory 32 of the job transmission device 14, but the program repository 34 may be stored in another device (for example, server) capable of communicating with the job transmission device 14 and the information processing apparatus 16. That is, the processing control program may be stored in a device other than the job transmission device 14 and the information processing apparatus 16.

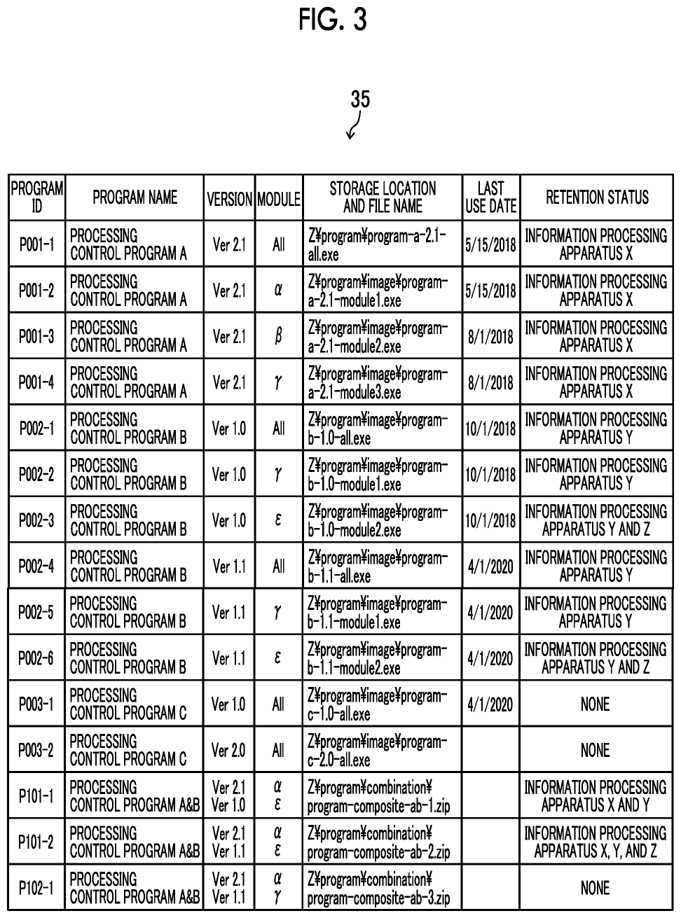

Information regarding the processing control program stored in the program repository 34 or the module of the processing control program is stored in the program DB 35. FIG. 3 illustrates an example of the program DB 35. The program DB 35 is, for example, a table for managing information regarding the processing control program managed by the job transmission device 14.

In the program DB 35 in the exemplary embodiment, identification information (program ID) capable of uniquely identifying the processing control program is managed in association with information, for example, name information of the processing control program indicated by the program ID, version information of the processing control program, the module forming the processing control program, a storage location and a file name of the processing control program, the last use date, the retention status of the processing control program in the information processing apparatus 16, and the like.

For example, the example in FIG. 3 illustrates that the processing control program A is configured by three modules which are a module α indicated by the program ID “P001-2”, a module β indicated by the program ID “P001-3”, and the module γ indicated by the program ID “P001-4”, and the entire program including all the modules is managed by the program ID “P001-1”. The program version of the processing control program A indicated by the program ID “P001-1” is version 2.1.

The item of the retention status indicates whether or not the information processing apparatus 16 that has once executed the processing related to the job using the processing control program or the module retains the processing control program or the module (details will be described later). The example in FIG. 3 illustrates that, in a case of the processing control program A indicated by the program ID “P001-1”, the information processing apparatus X has executed the processing related to the job using the processing control program A on May 15, 2018, and then retained the processing control program A. Information indicating whether or not the information processing apparatus 16 retains the processing control program or the module is used to determine whether or not, in a case where a new job of executing processing using the processing control program or the module is requested, the correspondence processing control program or the corresponding module is required to be transmitted to the information processing apparatus 16 (details will be described later).

In the example of FIG. 3, as described above, the modules α, β, and γ forming the processing control program A are managed in the program DB 35 as individual modules.

In the exemplary embodiment, a processing control program B, a processing control program C, and a processing control program A&B are registered as the processing control programs other than the processing control program A. Among the registered programs, two versions of version 1.0 and version 1.1 are managed as program versions for the processing control program B. The processing control program A&B is a program used to perform a function in which the modules of the two processing control programs are combined. Such a program is referred to as a complex processing program below. For example, the example in FIG. 3 illustrates that the complex processing program indicated by the program ID “P101-1” is capable of executing processing in which the module α of version 2.1 of the processing control program A and the module ε of version 1.1 of the processing control program B are combined.

As described above, since a processing control program or a module used to perform a requested job are managed in the program DB 35, it is possible to specify the processing control program or the module for executing processing defined in the job.

Information regarding a user who inputs a job to the job transmission device 14 is stored in the user DB 36. A user is registered in the information processing apparatus 16 by the administrator of the information processing apparatus 16 or the user. Various types of information input in user registration are stored in the user DB 36.

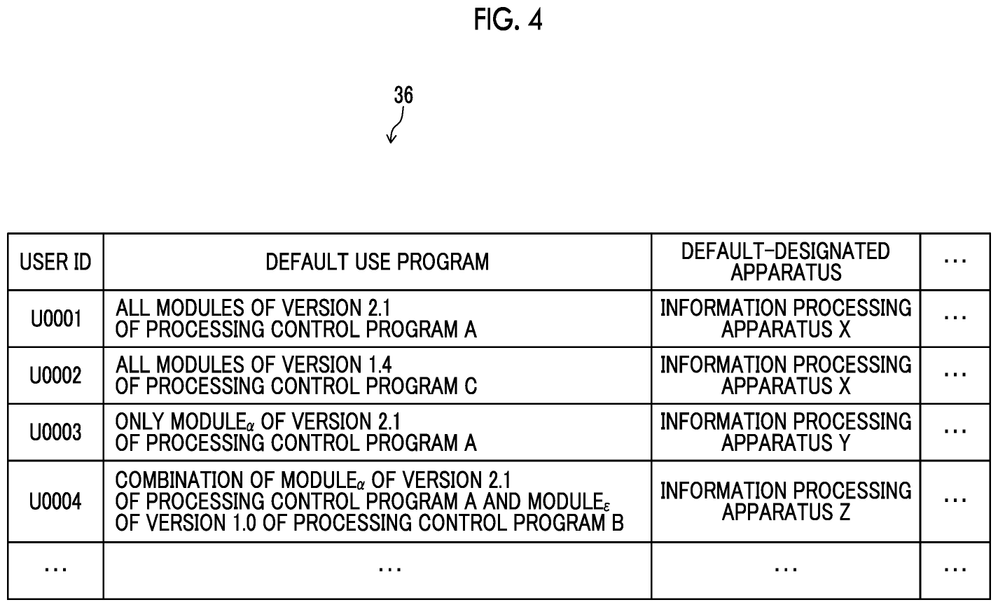

FIG. 4 is a diagram illustrating an example of contents of the user DB 36. In the exemplary embodiment, a user ID, a default use program, and a default designated apparatus are stored in the user DB 36 in association with each other.

The user ID is an identifier for uniquely identifying a user and is assigned by the information processing apparatus 16 in user registration.

The default use program is information indicating the initial setting of the processing control program used by the user. Alternatively, the default use program may indicate the initial setting of the version of the processing control program used by the user, or the initial setting of the module of the processing control program used by the user.

For example, the example in FIG. 4 illustrates that the initial setting of the processing control program used by a user indicated by the user ID “U0001” corresponds to all modules of version 2.1 of the processing control program A. The example in FIG. 4 also illustrates that the initial setting of the processing control program used by a user indicated by the user ID “U0002” corresponds to all modules of version 1.4 of the processing control program C. As described above, the default use program may have setting that varies depending on the user. The example in FIG. 4 also illustrates that the initial setting of the processing control program used by a user indicated by the user ID “U0003” corresponds to only the module α of version 2.1 of the processing control program A. As described above, only a module of a certain processing control program may be enabled to be set as the default use program. The example in FIG. 4 also illustrates that the initial setting of the processing control program used by a user indicated by the user ID “U0004” corresponds to a combination of the module α of version 2.1 of the processing control program A and the module ε of version 1.0 of the processing control program B. As described above, a combination of a plurality of modules in different processing control programs may be enabled to be set as the default use program.

In a case where the information processing system 10 includes a plurality of information processing apparatuses 16, the user designates the information processing apparatus 16 for processing a job. The default designated apparatus in a case where the designated information processing apparatus 16 performs the job corresponds to information indicating the initial setting of the information processing apparatus 16 designated by the user. For example, the example in FIG. 4 illustrates that the initial setting of the information processing apparatus 16 designated by the user indicated by the user ID “U0001” is the information processing apparatus X. The example in FIG. 4 also illustrates that the initial setting of the information processing apparatus 16 designated by the user indicated by the user ID “U0003” is an information processing apparatus Y. As described above, the default designated apparatus may have setting that varies depending on the user.

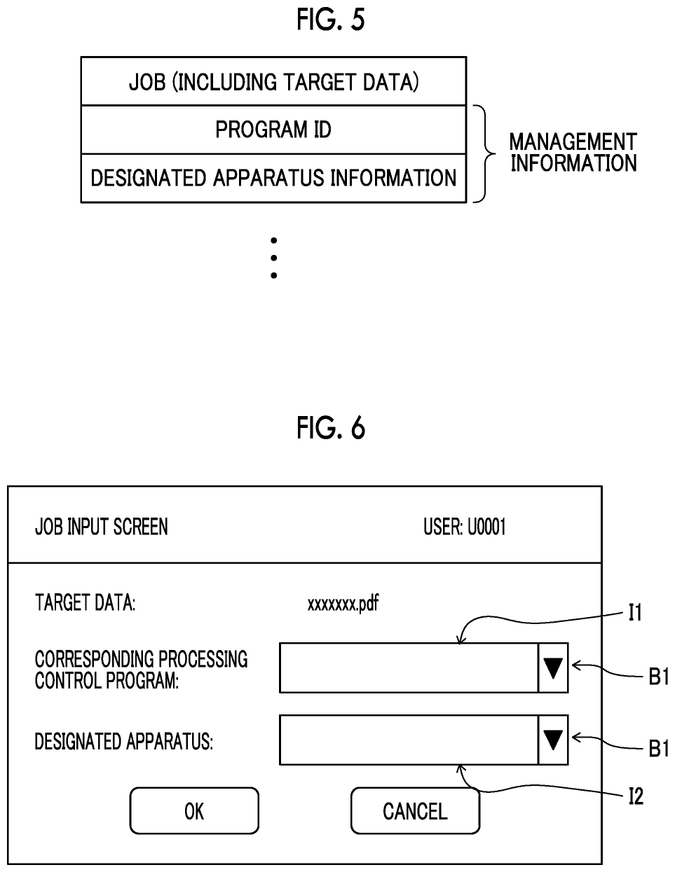

Returning to FIG. 2, the job received by the job transmission device 14 is temporarily stored in the job spool 38. Thus, the job transmission device 14 can temporarily retain the job. FIG. 5 is a diagram illustrating an example of contents of the job spool 38. As illustrated in FIG. 5, a job and management information associated with the job are stored in the job spool 38. FIG. 5 illustrates a combination of one job and one piece of management information. A plurality of such combinations may be stored in the job spool 38.

The management information includes a program ID indicating a processing control program that is specified by the program specifying unit 44 described later and corresponds to the job, and designated-apparatus information indicating the information processing apparatus 16 as a transmission destination of the job. In a case where the information processing system 10 includes only one information processing apparatus 16, the designated-apparatus information may be omitted in the management information.

Returning to FIG. 2, in the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. As illustrated in FIG. 2, the processor 40 performs functions as a user specifying unit 42, a program specifying unit 44, and a transmission control unit 46 by the processing request transmission program stored in the memory 32.

The user specifying unit 42 specifies a user who has input a job to the job transmission device 14. In a case where the communication interface 30 receives a job from the user terminal 12, the user terminal 12 transmits the job and a user ID indicating the user related to the job, to the job transmission device 14. The user specifying unit 42 specifies the user who has input the job, based on the received user ID. In a case where the user operates the input interface of the job transmission device 14 to input a job, the job transmission device 14 performs user authentication processing, and the user specifying unit 42 specifies the user who has input the job, based on the user ID obtained by the user authentication processing.

The program specifying unit 44 specifies the processing control program corresponding to the job received by the job transmission device 14. In this specification, the processing control program corresponding to the job received by the job transmission device 14 is referred to as a “correspondence processing control program” of the job. In particular, the program specifying unit 44 specifies the correspondence processing control program from the processing control programs or the modules stored in the program repository 34. The correspondence processing control program of the job is a processing control program required to process target data included in the job. In other words, the correspondence processing control program is a processing control program used by the information processing apparatus 16 in a case where the target data included in the job is processed.

The program specifying unit 44 may specify one version of a plurality of versions of the processing control program, as the correspondence processing control program. In particular, the program specifying unit 44 may specify the version corresponding to the user specified by the user specifying unit 42 as the correspondence processing control program among a plurality of versions of the processing control program. In such a case, for example, as described above, the function to be executed, which is specified based on the job received from the user and processing target data and the processing control program capable of executing the function may be specified, and then, among a plurality of versions of the specified processing control program, the version corresponding to the user may be specified. It is possible to specify an appropriate version for the user and execute processing for each received job or each function of the processing target data, by adopting such an exemplary embodiment.

The program specifying unit 44 may specify at least one module in the processing control program, as a correspondence processing control program. That is, in this case, a portion of the processing control program, not the whole, may be the correspondence processing control program. One version of a plurality of versions of the module in the processing control program may be specified as the correspondence processing control program. In particular, the program specifying unit 44 may specify the module or the version of the module, which corresponds to the user specified by the user specifying unit 42 in a module group in the processing control program, as the correspondence processing control program. The program specifying unit 44 may specify a combination of a plurality of modules in different processing control programs, as a correspondence processing control program.

The program specifying unit 44 may specify the correspondence processing control program by specifying the function to be executed from the contents of the received job and the data to be processed. For example, in a case where the received job has the contents of performing a function X and performing a function Y in response to the result, the program specifying unit specifies a processing control program capable of performing the function X and a processing control program capable of performing the function Y, as the correspondence processing control program corresponding to the job. In a case where the processing control program is divided into a plurality of modules and there is a module capable of performing the specified function, for example, a module capable of performing the function X and the function Y may be specified as the correspondence processing control program.

In another case, in a case where target data in the received job is divided into a plurality of pieces of target data, the function Y is performed on divided first data after the function X is performed, only a function Z is performed on second data, and data in which a processing result for the first data and a processing result for the second data are integrated is generated, a program group including a processing control program capable of executing processing of dividing data, a processing control program capable of performing the function X, a processing control program capable of performing the function Y, and a processing control program capable of executing processing of integrating data is specified as the correspondence processing control program. In such a case, for example, it is possible to transmit information indicating a target data group and a processing control program for executing processing, to the information processing apparatus 16 in a form of being associated with each data group.

Some methods are provided as a method for the program specifying unit 44 to specify the correspondence processing control program. As the first method, the program specifying unit 44 may specify the correspondence processing control program based on the user specified by the user specifying unit 42 and the user DB 36. In this case, the program specifying unit 44 specifies the default use program associated with the user ID of the user specified by the user specifying unit 42 (that is, the user who has input the job to the job transmission device 14) in the user DB 36, as a correspondence processing control program of a job. That is, in this case, since the program specifying unit 44 specifies the correspondence processing control program for the job input by the user, in accordance with the user, it can be said that the correspondence processing control program corresponding to the user is specified.

In the exemplary embodiment, a case where the user specifying unit 42 specifies a specific user is described as an exemplary embodiment. The user specifying unit is not limited to specifying of a user. For example, an organization including a plurality of users may manage a processing control program or a module to be used, and versions of the processing control program or the module, in accordance with the assumed use state. That is, for example, a company may receive a recommendation of using a specific processing control program, a specific module, or a specific version of the processing control program or the module. In another case, even in the identical company, a processing control program, a module, or a version of the processing control program or the module, which is to be used may be managed in accordance with the department, the group, and the point. In such a case, the user specifying unit 42 specifies the organization or the point to which the user who has input the job belongs, the organization that manages the job transmission device 14, or the organization or the point in which the job transmission device is installed. In this state, the user specifying unit 42 specifies a processing control program or a module which is available in the organization or the point, as the correspondence processing control program. According to such an exemplary embodiment, it is possible for a user belonging to an organization to obtain a uniform output result without setting a program available for each user.

For example, in a case where the job transmission device 14 receives a job from the user indicated by the user ID “U0001”, and the user specifying unit 42 specifies the user, the program specifying unit 44 refers to the user DB 36 (see FIG. 4) to specify all modules of version 2.1 of the processing control program A as the correspondence processing control program for the job. As described above, in a case where the version of the processing control program is designated in the default use program of the user DB 36, the program specifying unit 44 may specify the processing control program of the version corresponding to the user, as the correspondence processing control program.

For example, in a case where the job transmission device 14 receives a job from the user indicated by the user ID “U0003”, and the user specifying unit 42 specifies the user, the program specifying unit 44 refers to the user DB 36 to specify the module α of version 2.1 of the processing control program A as the correspondence processing control program corresponding to the job. As described above, in a case where the module is designated in the default use program of the user DB 36, the program specifying unit 44 may specify the module corresponding to the user as the correspondence processing control program.

For example, in a case where the job transmission device 14 receives a job from the user indicated by the user ID “U0004”, and the user specifying unit 42 specifies the user, the program specifying unit 44 refers to the user DB 36 to specify a combination of the module α of version 2.1 of the processing control program A and the module β of version 1.0 of the processing control program B, as the correspondence processing control program corresponding to the job. As described above, the program specifying unit 44 may specify a combination of a plurality of modules in different processing control programs, as the correspondence processing control program.

The program specifying unit 44 may specify the information processing apparatus 16 as a transmission destination of a job by a similar method. That is, the program specifying unit 44 specifies, in the user DB 36, the default designated apparatus associated with the user ID of the user specified by the user specifying unit 42, as the information processing apparatus 16 being the transmission destination of the job. In a case where the information processing system 10 includes only one information processing apparatus 16, processing of specifying the information processing apparatus 16 as the transmission destination of the job may be omitted.

As a second method, the program specifying unit 44 may specify the correspondence processing control program in accordance with an instruction of the user. In a case where the user inputs a job to the job transmission device 14, the user selects a correspondence processing control program for the job. For example, in a case where the user inputs a job to the job transmission device 14, a job input screen as illustrated in FIG. 6 is displayed on a display of the user terminal 12 or a display of the job transmission device 14. The job input screen is provided with an input field I1 for inputting a correspondence processing control program. The user inputs to a correspondence processing control program in the input field I1 to designate the correspondence processing control program for the job. The user may also input the version of the processing control program, the module of the processing control program, or a combination of a plurality of modules in different processing control programs in the input field I1, as the correspondence processing control program. The user may operate a button B1 provided in the input field I1 and thus a list of the processing control programs or the modules stored in the program repository 34 may be displayed, and the user may be able to select the correspondence processing control program of the job from the list. In a case where an OK button is operated, information indicating the designated correspondence processing control program is input to the job transmission device 14 together with the job. The program specifying unit 44 specifies the correspondence processing control program for the job based on the information. According to this method, the program specifying unit 44 may also specify a different correspondence processing control program for each job from the identical user.

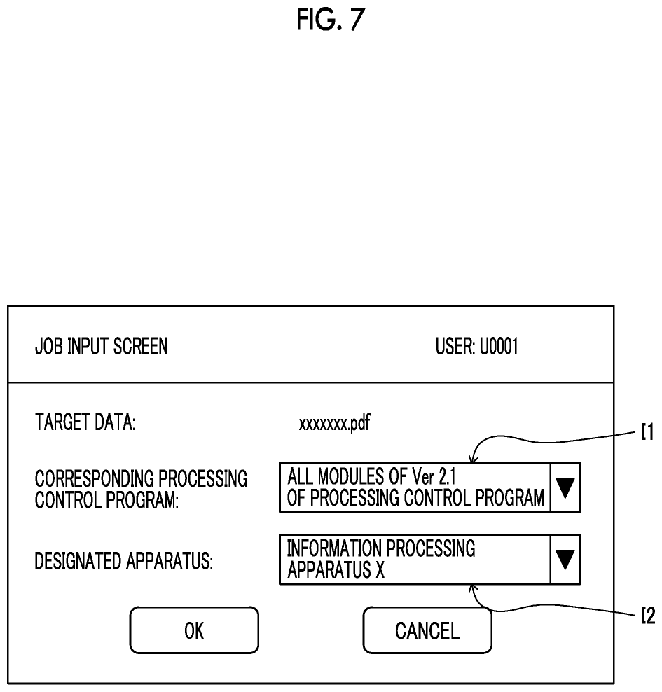

In a case where the user specifying unit 42 has already specified the user when the job input screen is displayed, the program specifying unit 44 may input the default use program of the user specified by referring to the user DB 36 in the input field I1 in advance, as illustrated in FIG. 7. In this manner, in a case where the correspondence processing control program corresponding to the job is the default use program, the user is able to operate the OK button by omitting the selection operation of the correspondence processing control program. Also in this case, the user is able to input another processing control program or another module into the input field I1.

The program specifying unit 44 may specify the information processing apparatus 16 as a transmission destination of a job by a similar method. That is, the job input screen is provided with an input field I2 for inputting the information processing apparatus 16 as the transmission destination of the job. The user inputs the information processing apparatus 16 in the input field I2 to designate the information processing apparatus 16 as the transmission destination of the job. The user may operate a button B2 provided in the input field I2 and thus a list of the information processing apparatuses 16 to which the job transmission device 14 is able to transmit the job may be displayed, and the user may be able to select the information processing apparatus 16 as the transmission destination of the job from the list. In a case where the user specifying unit 42 has already specified the user when the job input screen is displayed, the program specifying unit 44 may input the default designated apparatus of the user specified by referring to the user DB 36 in the input field I2 in advance, as illustrated in FIG. 7. In a case where the OK button is operated, information indicating the selected information processing apparatus 16 is input to the job transmission device 14 together with the job. The program specifying unit 44 specifies the information processing apparatus 16 as the transmission destination of the job, based on the information.

The program specifying unit 44 stores the program ID indicating the specified correspondence processing control program and designated-apparatus information indicating the specified information processing apparatus 16, as management information of the job, in the job spool 38.

Returning to FIG. 2, the transmission control unit 46 associates the job received from the user with the information indicating the correspondence processing control program for the job, and transmits the resultant of the association to the information processing apparatus 16. In a case where the information processing system 10 includes a plurality of information processing apparatuses 16, the transmission control unit 46 transmits information indicating a job and a correspondence processing control program to the information processing apparatus 16 specified by the program specifying unit 44. Specifically, the transmission control unit 46 takes out a job from the job spool 38 and specifies the information processing apparatus 16 as the transmission destination, based on the designated-apparatus information associated with the job. Then, the transmission control unit 46 transmits the correspondence program information indicating the correspondence processing control program based on the job and the program ID associated with the job, to the specified information processing apparatus 16. In a case where the correspondence processing control program is a certain version of a certain processing control program or at least one module, the correspondence program information is assumed to indicate the version of the processing control program or at least one module.

The correspondence program information indicates a program used to execute processing based on a job as a processing request. As an example, the correspondence program information refers to the correspondence processing control program itself, or information (for example, program ID) capable of uniquely specifying a program for executing processing.

In a case where the correspondence program information is the correspondence processing control program itself, the transmission control unit 46 takes out the correspondence processing control program from the program repository 34 and transmits the correspondence processing control program to the information processing apparatus 16. In a case where the program repository 34 is stored in another device, the transmission control unit 46 causes this device to transmit the correspondence processing control program to the information processing apparatus 16.

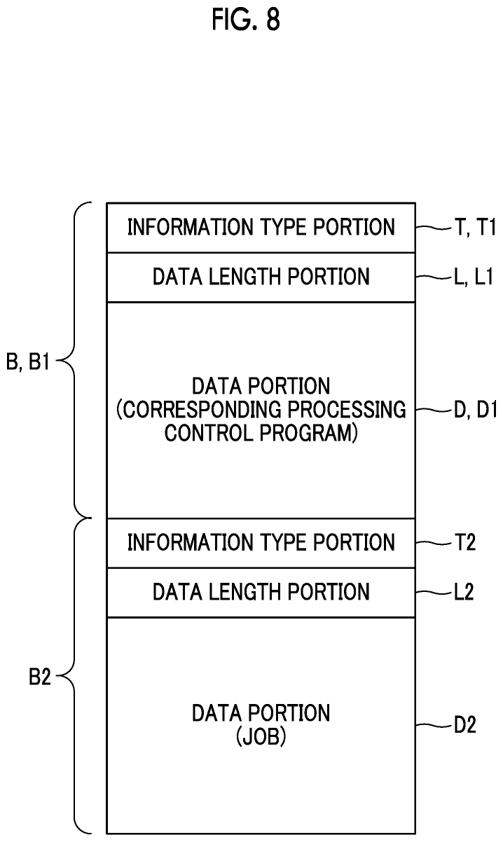

Ina case where the job and the correspondence processing control program for the job are transmitted from the job transmission device 14 to the information processing apparatus 16, the transmission control unit 46 may transmit a job file to the information processing apparatus 16. The job file is generated, as a processing request file, by linking the job and the correspondence processing control program. FIG. 8 illustrates an example of a data structure of the job file. In the example of FIG. 8, the job file includes two linked data blocks B (B1 and B2). Each of the data blocks B includes an information type portion T, a data length portion L, and a data portion D. The information type portion T represents the type of information in the data portion D, and the data length portion L indicates the data length of the data portion D. In the exemplary embodiment, it is assumed that a data portion D1 of a data block B1 is a correspondence processing control program, the information type portion T1 of the data block B1 indicates that the data portion D1 is the correspondence processing control program, and the data length portion L1 of the data block B1 indicates the data length of the correspondence processing control program. In the exemplary embodiment, it is assumed that a data portion D2 of the data block B2 is a job, the information type portion T2 of the data block B2 indicates that the data portion D2 is a job, and the data length portion L2 of the data block B2 is the data length of the job.

In a case where the correspondence program information is a program ID for identifying the correspondence processing control program, the transmission control unit 46 acquires the program ID associated with the job in the job spool 38 and transmits the program ID to the information processing apparatus 16. As will be described later, the information processing apparatus 16 acquires the correspondence processing control program from the program repository 34 based on the program ID.

The transmission control unit 46 is capable of transmitting the job and the correspondence program information to the information processing apparatus 16 in response to an instruction from the user who has input the job to the job transmission device 14. Alternatively, in a case where the job transmission device 14 includes a job scheduler that defines the timing of transmitting the job, the transmission control unit 46 may transmit the job and the correspondence program information to the information processing apparatus 16 at a timing according to the instruction of the job scheduler.

In a case where a plurality of jobs corresponding to the identical correspondence processing information program are stored in the job spool 38, the transmission control unit 46 may collect the plurality of jobs and transmit the collection to the information processing apparatus 16 together with the information indicating the correspondence processing information program. In particular, in a case where a plurality of jobs that correspond to the identical correspondence processing information program and in which the information processing apparatuses 16 indicated by the designated-apparatus information are identical to each other are stored in the job spool 38, the transmission control unit 46 may collect the plurality of jobs and transmit the collection to the information processing apparatus 16 together with the information indicating the correspondence processing information program.

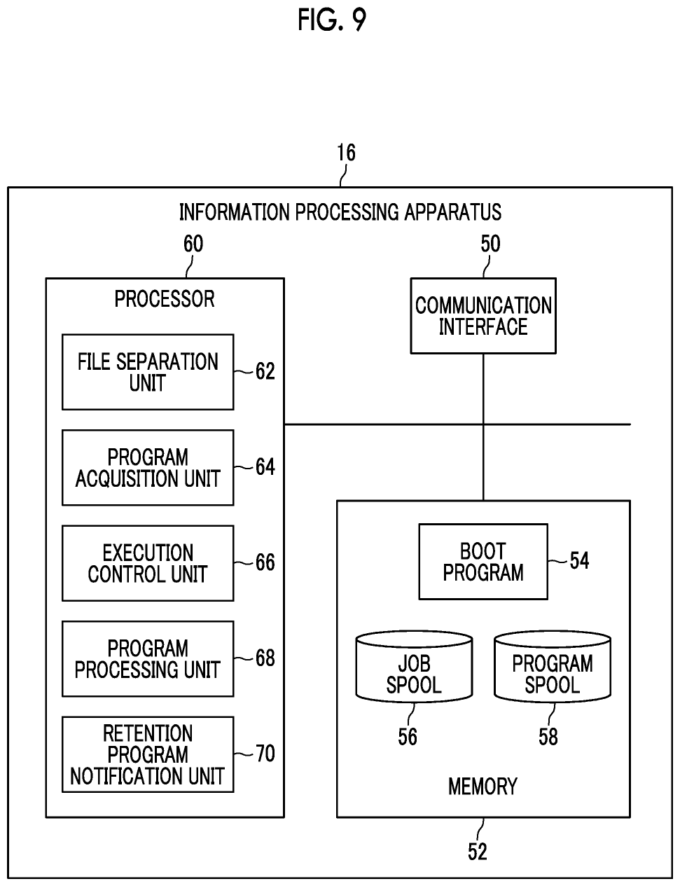

FIG. 9 is a schematic diagram illustrating a configuration of the information processing apparatus 16. A representative example of the information processing apparatus 16 is a printer controller that executes the above-described rasterization processing, a writing device that executes the above-described writing processing, or the like. The information processing apparatus 16 may be any device so long as the device performs the functions described below.

A communication interface 50 includes, for example, a network adapter. The communication interface 50 performs a function of communicating with another device via the communication line 18. The communication interface 50 receives job and correspondence program information from the job transmission device 14.

A memory 52 includes, for example, a HDD, an SSD, a ROM, and a RAM. The memory 52 may be provided separately from the processor 60 described later, or at least a portion of the memory may be provided in the processor 60. An information processing program for operating the units of the information processing apparatus 16 is stored in the memory 52. As illustrated in FIG. 9, a boot program 54, a job spool 56, and a program spool 58 are defined in the memory 52.

The boot program 54 is a program for developing the correspondence processing control program onto the memory 52. In a case where the boot program 54 is executed, a base for developing the correspondence processing control program is formed on the memory 52. The base is like a frame of the correspondence processing control program and has no actual function. It is possible to execute the correspondence processing control program having an actual function by developing the correspondence processing control program onto the base.

The job received from the job transmission device 14 by the information processing apparatus 16 is temporarily stored in the job spool 56. In a case where processing related to the job is completed, the job is deleted from the job spool 56 by a processor 60 described later.

The correspondence processing control program of the job is stored in the program spool 58 after processing on target data included in the job is completed. Details of processing of storing the correspondence processing control program into the program spool 58 will be described later together with processing of a program processing unit 68 in the processor 60.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. As illustrated in FIG. 9, the processor 60 functions as a file separation unit 62, a program acquisition unit 64, an execution control unit 66, a program processing unit 68, and a retention program notification unit 70 by the information processing program stored in the memory 52.

In a case where the information processing apparatus 16 receives a job file in which the job and the correspondence processing control program are linked to each other, from the job transmission device 14, the file separation unit 62 execute separation processing of separating the job and the correspondence processing control program from the job file prior to processing on target data included in the job. For example, in a case where the job file has a data structure illustrated in FIG. 8, the file separation unit 62 separates the job file into data blocks B based on the data length indicated by the data length portion L. The file separation unit specifies whether the data portion D of each data block B is a correspondence processing control program or a job, based on information indicated by the information type portion T of each data block B. Since the file separation unit 62 executes the separation processing of the job file, the information processing apparatus 16 acquires the job and the correspondence processing control program.

In a case where the information processing apparatus 16 separately receives the job and the correspondence processing control program, or in a case where the information processing apparatus 16 receives the job and the program ID of the correspondence processing control program, execution of the separation processing by the file separation unit 62 is not required.

In a case where the information processing apparatus 16 receives the job and the program ID indicating the correspondence processing control program from the job transmission device 14, the program acquisition unit 64 acquires the correspondence processing control program based on the program ID. Specifically, the program acquisition unit 64 transmits a transmission request of the correspondence processing control program together with the program ID, to a device having the program repository 34 (job transmission device 14 in the exemplary embodiment). The device having the program repository 34 acquires the correspondence processing control program from the program repository 34 and transmits the acquired correspondence processing control program to the information processing apparatus 16 based on the received program ID. Thus, the program acquisition unit 64 acquires the correspondence processing control program.

The execution control unit 66 firstly develops the acquired correspondence processing control program on the memory 52. Specifically, the execution control unit 66 first executes the boot program 54, and forms a base for the correspondence processing control program on the memory 52. In this state, the execution control unit 66 develops the correspondence processing control program on the formed base. In detail, in a case where the correspondence processing control program is acquired in an installer format, an installer is executed to develop the correspondence processing control program. In other words, the correspondence processing control program is installed on the memory 52. In a case where the correspondence processing control program is acquired in an archive format, the correspondence processing control program is developed by decompressing the archive format file.

The execution control unit 66 execute the correspondence processing control program developed onto the memory 52 to execute processing on target data included in the job corresponding to the correspondence processing control program. Here, in a case where the correspondence processing control program is one or a plurality of modules, the execution control unit 66 performs at least one module to execute the processing on the target data included in the job.

For example, in a case where the job is a printing job and the correspondence processing control program is a print control program, the execution control unit 66 executes the print control program to execute rasterization processing on the target data. Thus, the target data described in PDL is converted into a data format (for example, bitmap format) recognizable by the printing device. Then, the execution control unit 66 transmits the rasterized target data from the communication interface 50 to the printing device, and causes the printing device to execute printing processing of printing the target data on a print medium. Accordingly, the printing job is completed.

For example, in a case where the job is a writing job of requesting writing of target data to a recording medium and the correspondence processing control program is a writing control program, the execution control unit 66 executes the writing control program to execute compression processing of compressing the volume of the target data. Then, the execution control unit 66 transmits the compressed target data from the communication interface 50 to the writing device, and causes the writing device to execute writing processing of writing the target data to a recording medium such as a DVD. Accordingly, the writing job is completed.

The function of actually executing the processing related to the job (function of the above-described printing device or writing device) may be built in the information processing apparatus 16, so that the information processing apparatus 16 may execute the processing related to the job.

The program processing unit 68 executes the processing for the correspondence processing control program of the job after the processing on the target data included in the job is completed. Specifically, the program processing unit 68 is capable of retaining the correspondence processing control program in the memory 52 after the processing on the target data is completed.

Two methods as follows are provided as a method of retaining the correspondence processing control program in the memory 52.

As a first method, the program processing unit 68 maintains the correspondence processing control program in a state of being developed on the memory 52 after the processing on the target data is completed. For example, in a case where the correspondence processing control program is in the installer format, the program processing unit 68 maintains the correspondence processing control program installed on the memory 52. In a case where the correspondence processing control program is in the archive format, the program processing unit 68 maintains a file related to the correspondence processing control program developed on the memory 52. Thus, in a case where the job associated with the correspondence processing control program is received again from the job transmission device 14, the execution control unit 66 is capable of executing the processing on the target data in the job without executing the boot program 54 and executing developing processing of the correspondence processing control program.

As a second method, the program processing unit 68 deletes the file related to the correspondence processing control program developed on the memory 52 after the processing on the target data is completed, but stores the correspondence processing control program itself in the program spool 58. For example, in a case where the correspondence processing control program is in the installer format, the program processing unit 68 uninstalls the correspondence processing control program from the memory 52 and stores the installer in the program spool 58. In a case where the correspondence processing control program is in the archive format, the program processing unit 68 deletes the file related to the correspondence processing control program developed on the memory 52 and stores the archive file in the program spool 58. Thus, in a case where the job associated with the correspondence processing control program is received again from the job transmission device 14, the information processing apparatus 16 is capable of executing the processing on the target data in the job without a need to execute processing of acquiring the correspondence processing control program again.

The program processing unit 68 may delete the correspondence processing control program from the memory 52 after the processing on the target data is completed. Specifically, after the processing on the target data is completed, the program processing unit may delete the file related to the correspondence processing control program developed on the memory 52, and may delete the correspondence processing control program itself without storing the correspondence processing control program in the program spool 58. For example, in a case where the correspondence processing control program is in the installer format, the program processing unit 68 uninstalls the correspondence processing control program from the memory 52 and deletes the installer without storing the installer in the program spool 58. In a case where the correspondence processing control program is in the archive format, the program processing unit 68 deletes the file related to the correspondence processing control program developed on the memory 52, and deletes the archive file without storing the archive file in the program spool 58. Thus, it is possible to increase the free space of the memory 52.

Whether the program processing unit 68 retains the correspondence processing control program after the completion of the processing on the target data, in the memory 52, or deletes the program from the memory 52, or how the program processing unit 68 retains the correspondence processing control program in a case of retaining the program may be determined by an instruction of the user, related to the job. Alternatively, in the information processing apparatus 16, the processing to be executed by the program processing unit 68 may be determined in accordance with the setting predetermined by the administrator of the information processing apparatus 16 or the like.

In a case where the correspondence processing control program is retained in the memory 52 by the program processing unit 68, the retention program notification unit 70 transmits retention program information indicating the correspondence processing control program retained in the memory 52, to the job transmission device 14. The retention program information may be the program ID indicating the correspondence processing control program retained in the memory 52. The retention program notification unit 70 may intermittently (for example, periodically) transmit the retention program information to the job transmission device 14, or may transmit the retention program information to the job transmission device 14 in response to a request from the job transmission device 14.

For example, the retention program information may indicate a retention state of the correspondence processing control program in the memory 52. Specifically, the retention program information may indicate whether the correspondence processing control program is maintained to be developed on the memory 52, or the file related to the correspondence processing control program developed on the memory 52 is deleted and the correspondence processing control program itself is stored in the program spool 58.

In a case where the job transmission device 14 receives the retention program information from the information processing apparatus 16, the retention program information is stored in the memory 32 in association with an apparatus identifier for identifying the information processing apparatus 16 being a transmission source of the retention program information. For example, the job transmission device 14 may manage the retention state of the program in the information processing apparatus 16 by updating the program DB 35 illustrated in FIG. 3 based on the retention program information. That is, the item of the retention status in FIG. 3 may be updated based on the program ID included in the retention program information. In a case where a correspondence processing control program corresponding to a job (here, described as “another job”) to be transmitted to one information processing apparatus 16 is included in retention program information associated with the information processing apparatus 16, in other words, in a case where the correspondence processing control program corresponding to another job is retained in the memory 52 in the information processing apparatus 16, the transmission control unit 46 in the job transmission device 14 may not transmit the correspondence processing control program corresponding to this job, to the information processing apparatus 16. The execution control unit 66 in the information processing apparatus 16 executes the correspondence processing control program retained in the memory 52 to execute processing on target data of another job.

Specifically, in a case where the retention program information indicates that the correspondence processing control program is maintained to be developed on the memory 52, the transmission control unit 46 in the job transmission device 14 may transmit only other jobs to the information processing apparatus 16. The execution control unit 66 in the information processing apparatus 16 executes the correspondence processing control program developed on the memory 52 to execute processing on target data of another job.

In a case where the retention program information indicates a state where a file related to the correspondence processing control program developed on the memory 52 is deleted, and the correspondence processing control program itself is stored in the program spool 58, the transmission control unit 46 in the job transmission device 14 transmits another job and a program ID indicating the correspondence processing control program, to the information processing apparatus 16. The execution control unit 66 in the information processing apparatus 16 specifies the correspondence processing control program from the program spool 58, based on the program ID received from the job transmission device 14. The execution control unit 66 executes the boot program 54 to develop the specified correspondence processing control program in the memory 52. In this state, the execution control unit executes the developed correspondence processing control program to execute processing on target data of another job.

As another example, in a case where the information processing apparatus does not retain the correspondence processing control program based on the retention program information of the information processing apparatus 16, the job transmission device 14 transmits the correspondence processing control program to the information processing apparatus 16 together with data to be processed.

In a case where the other job and the correspondence processing control program corresponding to the other job are received from the job transmission device 14, the program acquisition unit 64 in the information processing apparatus 16 determines whether or not the correspondence processing control program indicated by the program ID is retained in the memory 52. In a case where the correspondence processing control program indicated by the program ID is retained in the memory 52, the program acquisition unit 64 may execute the correspondence processing control program retained in the memory 52 without executing processing of acquiring the correspondence processing control program again from the program repository 34, so as to execute processing on target data included in the other job. In a case where the correspondence processing control program indicated by the program ID is not retained in the memory 52, the program acquisition unit 64 acquires the correspondence processing control program from the program repository 34. In this state, the program acquisition unit 64 execute the correspondence processing control program to execute the processing on the target data included in the other job.

The outline of the information processing system 10 according to the present exemplary embodiment is as described above. In the information processing system 10, the correspondence processing control program corresponding to a job transmitted from the information processing apparatus 16 is specified in the job transmission device 14. In a state of acquiring the correspondence processing control program, the information processing apparatus 16 executes the correspondence processing control program to execute the processing on the target data included in the job. Since such a mechanism is provided, it is sufficient to be able to perform the function required for the job, as the correspondence processing control program. It is not required to be able to perform all functions which may be performed by the information processing apparatus 16. That is, it is possible to reduce the data size of the correspondence processing control program in comparison to a processing control program capable of performing all functions that may be performed by the information processing apparatus 16. Therefore, according to the exemplary embodiment, it is possible to reduce the storage area of the memory 52 for storing the correspondence processing control program in comparison to a case where a processing control program capable of performing all functions that may be performed by the information processing apparatus 16 is stored in the memory 52 of the information processing apparatus 16.

Since the correspondence processing control program is specified corresponding to the job, the user can execute the processing on the target data included in the job using the correspondence processing control program corresponding to the job. For example, the user can execute the processing on the target data for each job by using the correspondence processing control program proper for the preference of the user or the correspondence processing control program that matches the target data.

In a case where a plurality of versions of a certain processing control program (or module) are provided, the user is not necessarily required to use the latest version, and the user can use the version proper for the preference of the user. Thus, it is possible to perform a multi-version operation. With this, an effect that it is not required to perform version management (for example, management of normally maintaining a processing control program to the latest version) of the processing control program (or module) in the information processing apparatus 16 side is exhibited.

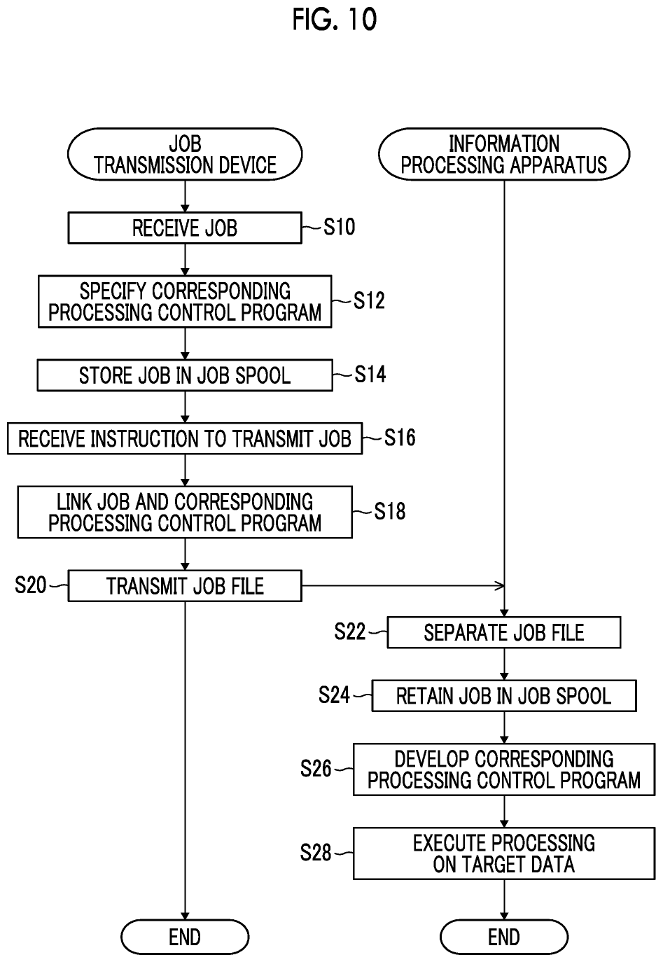

An example of a processing flow of the information processing system 10 will be described with reference to the flowchart illustrated in FIG. 10.

In Step S10, the job transmission device 14 receives a job from the user. For example, the communication interface 30 receives the job from the user terminal 12.

In Step S12, the program specifying unit 44 specifies a correspondence processing control program corresponding to the job received in Step S10. In a case where the information processing system 10 includes a plurality of information processing apparatuses 16, the program specifying unit 44 specifies the information processing apparatus 16 as the transmission destination of the job.

In Step S14, the processor 40 stores the job received in Step S10, in the job spool 38. Management information is associated with the job. The management information includes a program ID indicating the correspondence processing control program specified in Step S12, and designated-apparatus information indicating the information processing apparatus 16 as the transmission destination of the job.

In Step S16, the processor 40 receives an instruction to transmit the job, which is received in Step S10, from the user, the job scheduler, or the like.

In Step S18, the transmission control unit 46 generates a job file in which the job related to the transmission instruction in Step S16 and the correspondence processing control program for the job are linked.

In Step S20, the transmission control unit 46 transmits the job file generated in Step S18 to the information processing apparatus 16.

In Step S22, the file separation unit 62 in the information processing apparatus 16 separates the job file received in Step S20 and acquires the job and the correspondence processing control program.

In Step S24, the processor 60 stores the job acquired in Step S22, in the job spool 56.

In Step S26, the execution control unit 66 executes the boot program 54 to forma base on the memory 52, and then develops the correspondence processing control program acquired in Step S22 on the memory 52.

In Step S28, the execution control unit 66 execute the correspondence processing control program developed onto the memory 52 to execute processing on target data included in the job.

Hitherto, the exemplary embodiment of the present invention has been described, but the exemplary embodiment of the present invention is not limited to the above exemplary embodiment, and various modifications may be made without departing from the spirit of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processing request transmission device including a transmission-side processor configured to transmit, to an information processing apparatus, a processing request including target data to be processed and a correspondence program information indicating a correspondence processing control program being a processing control program corresponding to the processing request, in association with each other; and
the information processing apparatus including a processing-side processor configured to execute processing on the target data by executing the correspondence processing control program.

2. The information processing system according to claim 1, wherein
the transmission-side processor is configured to
specify the correspondence processing control program required for processing the target data, and
transmit the correspondence program information indicating the specified correspondence processing control program to the information processing apparatus.

3. The information processing system according to claim 2, wherein
the transmission-side processor is configured to
specify a user who requests the processing, and
specify the correspondence processing control program based on the specified user.

4. The information processing system according to claim 3, wherein
the correspondence processing control program has a version corresponding to the specified user among a plurality of versions of the processing control program.

5. The information processing system according to claim 1, wherein
the transmission-side processor is configured to transmit the correspondence processing control program as the correspondence program information, to the information processing apparatus.

6. The information processing system according to claim 2, wherein
the transmission-side processor is configured to transmit the correspondence processing control program as the correspondence program information, to the information processing apparatus.

7. The information processing system according to claim 3, wherein
the transmission-side processor is configured to transmit the correspondence processing control program as the correspondence program information, to the information processing apparatus.

8. The information processing system according to claim 4, wherein
the transmission-side processor is configured to transmit the correspondence processing control program as the correspondence program information, to the information processing apparatus.

9. The information processing system according to claim 5, wherein
the transmission-side processor is configured to transmit a processing request file in which the processing request and the correspondence processing control program are linked to each other, to the information processing apparatus, and
the processing-side processor is configured to execute separation processing of separating the target data and the correspondence processing control program from the processing request file before the processing on the target data.

10. The information processing system according to claim 6, wherein
the transmission-side processor is configured to transmit a processing request file in which the processing request and the correspondence processing control program are linked to each other, to the information processing apparatus, and
the processing-side processor is configured to execute separation processing of separating the target data and the correspondence processing control program from the processing request file before the processing on the target data.

11. The information processing system according to claim 7, wherein
the transmission-side processor is configured to transmit a processing request file in which the processing request and the correspondence processing control program are linked to each other, to the information processing apparatus, and
the processing-side processor is configured to execute separation processing of separating the target data and the correspondence processing control program from the processing request file before the processing on the target data.

12. The information processing system according to claim 5, wherein
the processing-side processor is configured to
retain the correspondence processing control program in a memory of the information processing apparatus after the processing on the target data is completed, and
transmit holding program information indicating the processing control program retained in the memory, to the processing request transmission device, and
the transmission-side processor is configured not to
transmit a correspondence processing control program corresponding to another processing request to the information processing apparatus in a case where the correspondence processing control program corresponding to the other processing request is retained in the memory based on the holding program information.

13. The information processing system according to claim 1, wherein
the transmission-side processor is configured to transmit a program ID for identifying the correspondence processing control program as the correspondence program information, to the information processing apparatus, and
the processing-side processor is configured to acquire the correspondence processing control program based on the program ID.

14. The information processing system according to claim 13, wherein
the processing-side processor is configured to
retain the correspondence processing control program in a memory of the information processing apparatus after the processing on the target data is completed, and
execute processing on target data included in another processing request by executing a correspondence processing control program retained in the memory in a case where the other processing request and a program ID indicating the correspondence processing control program corresponding to the other processing request are received from the processing request transmission device, and the correspondence processing control program indicated by the program ID is retained in the memory.

15. The information processing system according to claim 1, wherein
the processing-side processor is configured to delete the correspondence processing control program from a memory of the information processing apparatus after the processing on the target data is completed.

16. The information processing system according to claim 1, wherein
the processing control program is configured to include a plurality of modules, and
the transmission-side processor is configured to transmit correspondence program information indicating at least one module corresponding to the processing request to the information processing apparatus, and
the processing-side processor is configured to execute the processing on the target data by executing the at least one module.

17. The information processing system according to claim 1, wherein
the transmission-side processor is configured to transmit a collection of a plurality of processing requests corresponding to an identical correspondence processing control program to the information processing apparatus.

18. The information processing system according to claim 1, wherein
the processing request is a print processing request of causing a printing device to perform print processing of printing the target data on a print medium, and
the processing control program is a print control program of converting the target data into a data format recognizable by the printing device.

19. An information processing apparatus comprising:
a processing-side processor configured to
receive a processing request including target data to be processed and a program ID for identifying a correspondence processing control program being a processing control program corresponding to the processing request, from a processing request transmission device,
acquire the correspondence processing control program based on the program ID, and
execute processing on the target data by executing the correspondence processing control program.

20. A non-transitory computer readable medium storing an information processing program causing a computer to execute a process, the process comprising:
receiving a processing request including target data to be processed and a program ID for identifying a correspondence processing control program being a processing control program corresponding to the processing request, from a processing request transmission device;
acquiring the correspondence processing control program based on the program ID; and
executing processing on the target data by executing the correspondence processing control program.
